(19) United States
(12) Patent Application Publication
(10) Pub. No.: US 2016/0285735 A1
(43) Pub. Date: Sep. 29, 2016

(54) TECHNIQUES FOR EFFICIENTLY PROGRAMMING FORWARDING RULES IN A NETWORK SYSTEM

(71) Applicant: Brocade Communications Systems, Inc., San Jose, CA (US)

(72) Inventors: Xiaochu Chen, San Ramon, CA (US); Arvindsrinivasan Lakshmi Narasimhan, San Jose, CA (US); Latha Laxman, San Jose, CA (US); Shailender Sharma, Bangalore (IN); Ivy Pei-Shan Hsu, Dublin, CA (US); Sanjeev Chhabria, Castro Valley, CA (US); Rakesh Varimalla, Bangalore (IN)

(21) Appl. No.: 14/848,645

(22) Filed: Sep. 9, 2015

Related U.S. Application Data
(60) Provisional application No. 62/137,084, filed on Mar. 23, 2015.

(51) Int. Cl. H04L 12/751; H04L 12/721

(52) U.S. Cl. CPC H04L 45/02; H04L 45/38

(57) ABSTRACT

Techniques for efficiently programming forwarding rules in a network system are provided. In one embodiment, a control plane component of the network system can determine a packet forwarding rule to be programmed into a forwarding table of a service instance residing on a data plane component of the network system. The control plane component can then generate a message comprising the packet forwarding rule and a forwarding table index and transmit the message to a given service instance of the data plane component. Upon receiving the message, the data plane component can directly forward the message to the service instance. The packet forwarding rule can then be programmed into a forwarding table of the service instance, at the specified forwarding table index, without involving the management processor of the data plane component.

### CROSS REFERENCES TO RELATED APPLICATIONS

The present application claims the benefit and priority under 35 U.S.C. 119(e) of U.S. Provisional Application No. 62/137,084, filed Mar. 23, 2015, entitled “TECHNIQUES FOR EFFICIENTLY PROGRAMMING FORWARDING RULES IN A NETWORK VISIBILITY SYSTEM.” In addition, the present application is related to the following commonly-owned U.S. patent applications:
1. U.S. application Ser. No. 14,603,304, filed Jan. 22, 2015, entitled “SESSION-BASED PACKET ROUTING FOR FACILITATING ANALYTICS”;
2. U.S. application Ser. No. ______ (Attorney Docket No. 000119-007501US), filed concurrently with the present application, entitled “TECHNIQUES FOR EXCHANGING CONTROL AND CONFIGURATION INFORMATION IN A NETWORK VISIBILITY SYSTEM”; and
3. U.S. application Ser. No. ______ (Attorney Docket No. 000119-007801US), filed concurrently with the present application, entitled “TECHNIQUES FOR USER-DEFINED TAGGING OF TRAFFIC IN A NETWORK VISIBILITY SYSTEM.”

The entire contents of the foregoing provisional and nonprovisional applications are incorporated herein by reference for all purposes.

### BACKGROUND

Unless expressly indicated herein, the material presented in this section is not prior art to the claims of the present application and is not admitted to be prior art by inclusion in this section.

General Packet Radio Service (GPRS) is a standard for wireless data communications that allows 3G and 4G/LTE mobile networks to transmit Internet Protocol (IP) packets to external networks such as the Internet. FIG. 1 is a simplified diagram of an exemplary 3G network 100 that makes use of GPRS. As shown, 3G network 100 includes a mobile station (MS) 102 (e.g., a cellular phone, tablet, etc.) that is wirelessly connected to a base station subsystem (BSS) 104. BSS 104 is, in turn, connected to a serving GPRS support node (SGSN) 106, which communicates with a gateway GPRS support node (GGSN) 108 via a GPRS core network 110. Although only one of each of these entities is depicted in FIG. 1, it should be appreciated that any number of these entities may be supported. For example, multiple MSs 102 may connect to each BSS 104, and multiple BSSs 104 may connect to each SGSN 106. Further, multiple SGGNs 106 may interface with multiple GGSNs 108 via GPRS core network 110.

When a user wishes to access Internet 114 via MS 102, MS 102 sends a request message (known as an “Activate PDP Context” request) to SGSN 106 via BSS 104. In response to this request, SGSN 106 activates a session on behalf of the user and exchanges GPRS Tunneling Protocol (GTP) control packets (referred to as “GTP-C” packets) with GGSN 108 in order to signal session activation (as well as set/adjust certain session parameters, such as quality-of-service, etc.). The activated user session is associated with a tunnel between SGSN 106 and GGSN 108 that is identified by a unique tunnel endpoint identifier (TEID). In a scenario where MS 102 has roamed to BSS 104 from a different BSS served by a different SGSN, SGSN 106 may exchange GTP-C packets with GGSN 108 in order to update an existing session for the user (instead of activating a new session).

Once the user session has been activated/updated, MS 102 transmits user data packets (e.g., IPv4, IPv6, or Point-to-Point Protocol (PPP) packets) destined for an external host/network to BSS 104. The user data packets are encapsulated into GTP user, or “GTP-U,” packets and sent to SGSN 106. SGSN 106 then tunnels, via the tunnel associated with the user session, the GTP-U packets to GGSN 108. Upon receiving the GTP-U packets, GGSN 108 strips the GTP header from the packets and routes them to Internet 114, thereby enabling the packets to be delivered to their intended destinations.

The architecture of a 4G/LTE network that makes uses of GPRS is similar in certain respects to 3G network 100 of FIG. 1. However, in a 4G/LTE network, BSS 104 is replaced by an eNode-B, SGSN 106 is replaced by a mobility management entity (MME) and a Serving Gateway (SGW), and GGSN 108 is replaced by a packet data network gateway (PGW).

For various reasons, an operator of a mobile network such as network 100 of FIG. 1 may be interested in analyzing traffic flows within the network. For instance, the operator may want to collect and analyze flow information for network management or business intelligence/reporting. Alternatively or in addition, the operator may want to monitor traffic flows in order to, e.g., detect and thwart malicious network attacks.

To facilitate these and other types of analyses, the operator can implement a network telemetry, or “visibility,” system, such as system 200 shown in FIG. 2 according to an embodiment. At a high level, network visibility system 200 can intercept traffic flowing through one or more connected networks (in this example, GTP traffic between SGSN-GGSN pairs in a 3G network 206 and/or GTP traffic between eNodeB/MME-SGW pairs in a 4G/LTE network 208) and can intelligently distribute the intercepted traffic among a number of analytic servers 210(1)-(M). Analytic servers 210(1)-(M), which may be operated by the same operator/service provider as networks 206 and 208, can then analyze the received traffic for various purposes, such as network management, reporting, security, etc.

In the example of FIG. 2, network visibility system 200 comprises two components: a GTP Visibility Router (GVR) 202 and a GTP Correlation Cluster (GCC) 204. GVR 202 can be considered the data plane component of network visibility system 200 and is generally responsible for receiving and forwarding intercepted traffic (e.g., GTP traffic tapped from 3G network 206 and/or 4G/LTE network 208) to analytic servers 210(1)-(M).

GCC 204 can be considered the control plane of network visibility system 200 and is generally responsible for determining forwarding rules on behalf of GVR 202. Once these forwarding rules have been determined, GCC 204 can program the rules into GVR 202's forwarding tables (e.g., content-addressable memories, or CAMs) so that GVR 202 can forward network traffic to analytic servers 210(1)-(M) according to customer (e.g., network operator) requirements. As one example, GCC 204 can identify and correlate GTP-U packets that belong to the same user session but include different source (e.g., SGSN) IP addresses. Such a situation may occur if, e.g., a mobile user starts a phone call in one wireless access area serviced by one SGSN and then roams, during the same phone call, to a different wireless access area serviced by a different SGSN. GCC 204 can then create and program “dynamic” forwarding rules in GVR 202 that ensure these packets (which correspond to the same user session) are all forwarded to the same analytic server for consolidated analysis.

Additional details regarding an exemplary implementation of network visibility system 200, as well as the GTP correlation processing attributed to GCC 204, can be found in commonly-owned U.S. patent application Ser. No. 14/603,304, entitled “SESSION-BASED PACKET ROUTING FOR FACILITATING ANALYTICS,” the entire contents of which are incorporated herein by reference for all purposes.

In a conventional Software Defined Networking (SDN) environment where a control plane component defines forwarding rules for programming onto a hardware-based data plane component, the control plane component passes the forwarding rules to a central management processor of the data plane component. As used herein, a “hardware” or “hardware-based” data plane component is a physical network device, such as a physical switch or router, with a central management CPU and one or more ASIC-based line cards/packet processors. The management processor then communicates with one or more line card(s) of the data plane component and installs the forwarding rules into forwarding tables (e.g., CAMs) resident on the line card(s). While this approach is functional, it is also inefficient because it requires intervention by the management processor in order to carry out the programming process. In a system such as network visibility system 200 of FIG. 2, a large volume of forwarding rules may need to be programmed by GCC 204 onto GVR 202 on a continuous basis. Thus, using the conventional rule programming workflow described above, the management processor of GVR 202 can become a bottleneck that prevents this rule programming from occurring in a timely and scalable manner.

### SUMMARY

Techniques for efficiently programming forwarding rules in a network system are provided. In one embodiment, a control plane component of the network system can determine a packet forwarding rule to be programmed into a forwarding table of a service instance residing on a data plane component of the network system. The control plane component can then generate a message comprising the packet forwarding rule and a forwarding table index and transmit the message to a given service instance of the data plane component. Upon receiving the message, the data plane component can directly forward the message to the service instance. The packet forwarding rule can then be programmed into a forwarding table of the service instance, at the specified forwarding table index, without involving the management processor of the data plane component.

The following detailed description and accompanying drawings provide a better understanding of the nature and advantages of particular embodiments.

### BRIEF DESCRIPTION OF DRAWINGS

FIG. 1 depicts an exemplary 3G network.

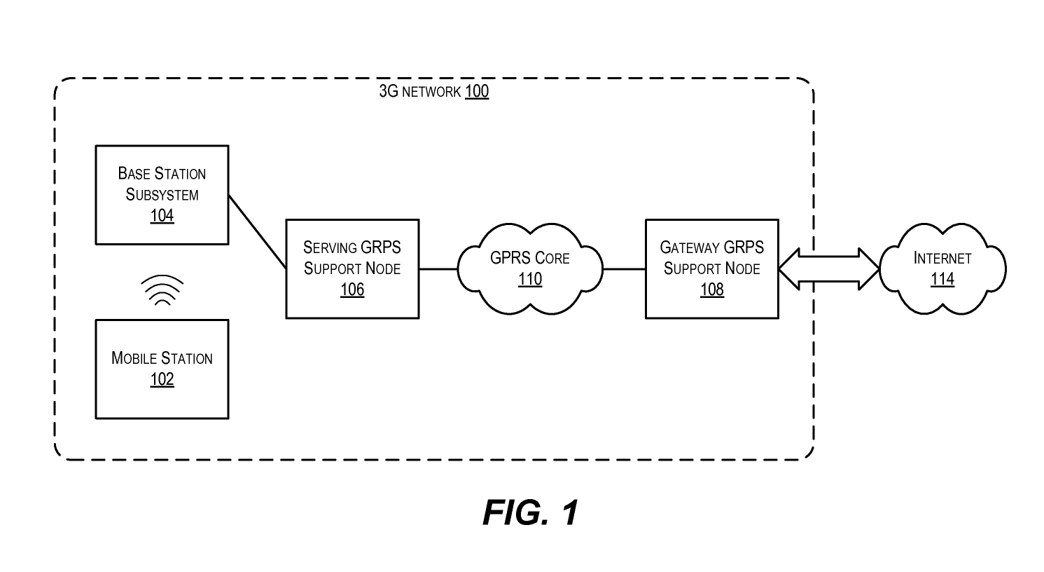

FIG. 2 depicts a network visibility system according to an embodiment.

FIG. 3 depicts a high-level workflow for efficiently programming forwarding rules in a network system according to an embodiment.

FIG. 4 depicts an architecture and runtime workflow for a specific network visibility system implementation according to an embodiment.

FIG. 5 depicts a workflow for efficiently programming forwarding rules within the network visibility system of FIG. 4 according to an embodiment.

FIG. 6 depicts a network switch/router according to an embodiment.

FIG. 7 depicts a computer system according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure provide techniques that enable a control plane component of a network system (e.g., an SDN-based system) to more efficiently program packet forwarding rules onto a data plane component of the system. In one embodiment, the data plane component can be a physical switch/router with a central management CPU and one or more ASIC-based line cards/packet processors. In other embodiments, the data plane component can be a virtual network device that is implemented using a conventional, general purpose computer system, With these techniques, the control plane component can directly program the rules into the forwarding tables of the data plane component, without requiring any intervention or intermediary processing by the data plane component's central management processor. This can significantly improve the speed and scalability of the rule programming workflow.

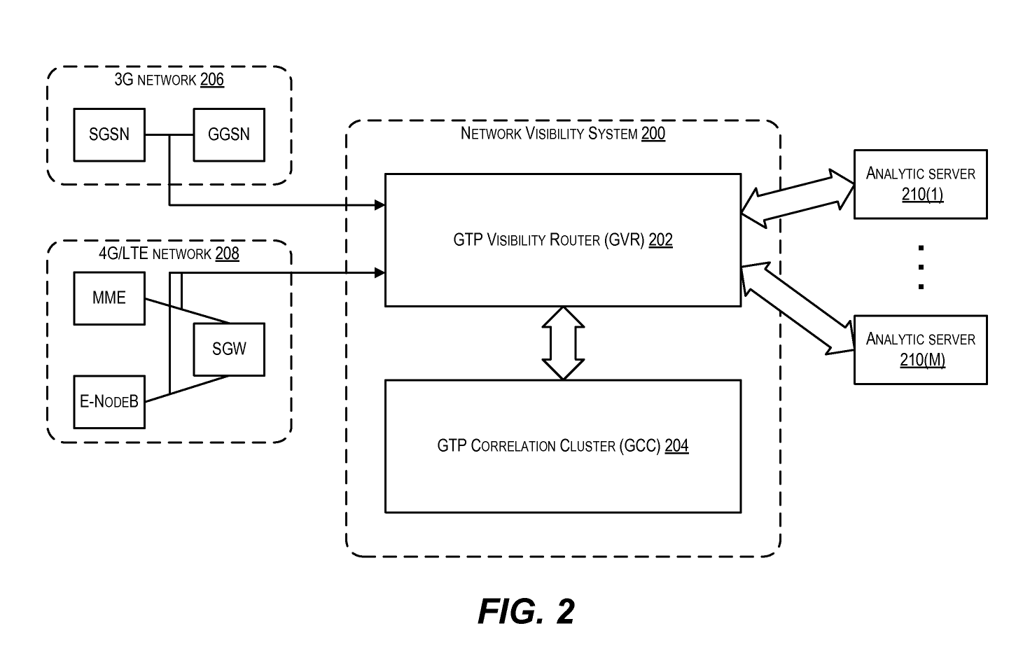

In certain embodiments, the techniques described herein can be used in the context of a network visibility system such as system 200 of FIG. 2 to efficiently program “dynamic” packet forwarding rules onto GVR 202. As mentioned previously, such dynamic rules can be generated by GCC 204 when, e.g., a mobile user migrates from an old wireless access area (covered by, e.g., an old SGSN/SGW) to a new wireless access area (covered by, e.g., a new SGSGN/SGW) within a single user session. In this scenario, the programming of the dynamic rules on GVR 202 can ensure that the mobile user's GTP-U packets (which will identify a different source (e.g., SGSN) IP address post-migration versus pre-migration) are all forwarded to the same analytic server for consolidated analysis.

These and other aspects of the present disclosure are described in further detail in the sections that follow.

### 2. High-Level Workflow

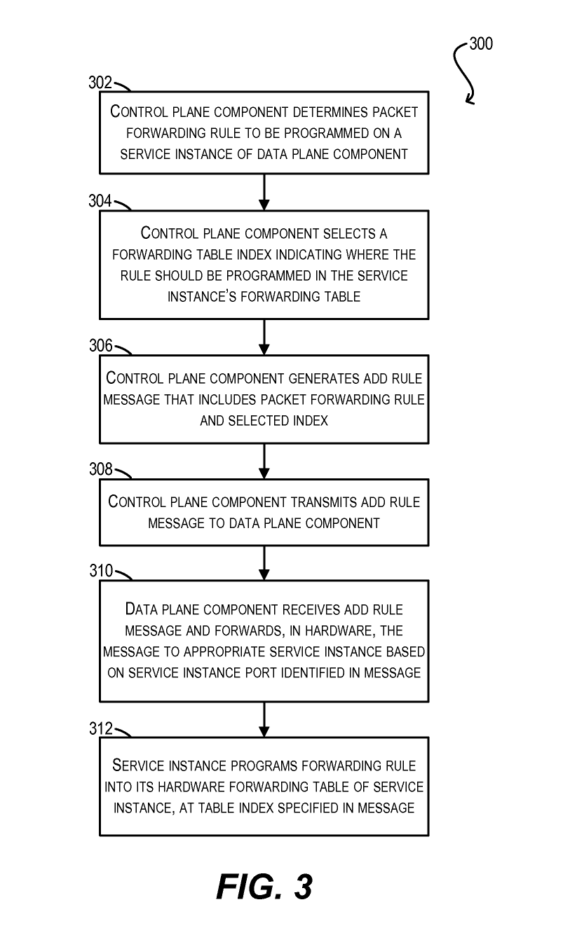

FIG. 3 depicts a high-level workflow 300 that can be performed by a control plane component and a data plane component of a network system to enable efficient rule programming on the data plane component according to an embodiment. Workflow 300 assumes that the data plane component is a hardware-based network device, such as a physical switch or router, that includes a central management processor (i.e., management CPU) and one or more ASIC-based “service instances” corresponding to line cards or packet processors. Each service instance is associated with a forwarding table, such as a CAM or a table in SRAM, that is configured to hold packet forwarding rules used by the service instance for forwarding incoming traffic to appropriate egress ports of the data plane component. In other embodiments, the data plane component can also be a virtual network device, where the functions of the virtual network device are implemented using a general purpose CPU and where the forwarding tables of the virtual network device are maintained in, e.g., DRAM.

Starting with block 302, the control plane component can first determine a packet forwarding rule to be programmed on a particular service instance of the data plane component. For instance, the packet forwarding rule can include one or more parameters to be matched against corresponding fields in a packet received at the data plane component, and an egress port for forwarding the packet (in the case where the packet fields match the rule parameters). Examples of such rule parameters include, e.g., source IP address, destination IP address, port, GTP tunnel ID (TEID), and so on.

At block 304, the control plane component can select a particular forwarding table index (also referred to as a “rule index”) indicating where the rule should be programmed in the service instance's forwarding table (e.g., CAM). For example, assume the service instance has a forwarding table with an available table index range of 1-100 (in other words, table entries 1-100 are available for insertion of new packet forwarding rules). In this case, the control plane component may select index 1 (or any other index between 1 and 100) for programming of the packet forwarding rule determined at block 302. In a particular embodiment, the control plane component may be made aware of the available table index range for this service instance (as well as other service instances configured on the data plane component) via an initial communication exchange with the data plane component that occurs upon boot-up/initialization.

At block 306, the control plane component can generate an “add rule” message that includes the packet forwarding rule determined at block 302 and the forwarding table index selected at block 304. This message can specify a destination address reflecting the data plane component's IP address and a port (e.g., UDP port) assigned to the service instance. Then, at block 308, the control plane component can send the “add rule” message to the data plane component.

At block 310, the data plane component can receive the “add rule” message on an ingress port and can directly forward the message to the service instance (e.g., line card) identified in the message's destination address. Significantly, the data plane component can perform this forwarding without sending the message, or a copy thereof, to the data plane component's central management processor. This process of sending the “add rule” message directly to the target service instance, without involving the software management plane of the data plane component, is referred to herein as forwarding the message “in hardware” to the service instance.

Finally, at block 312, a CPU residing on the receiving service instance can cause the packet forwarding rule included in the “add rule” message to be programmed in the service instance's forwarding table, at the specified table index. Note that since this rule programming is performed directly by the service instance, there is no overhead associated with having the data plane component's management processor involved in the programming workflow. Accordingly, this programming task can be performed significantly faster than conventional approaches that require intervention/orchestration by the management processor.

Although not shown in FIG. 3, a similar workflow can be performed for deleting a packet forwarding rule that has already been programmed into a forwarding table of the data plane component. In this “delete” scenario, the control plane component can transmit a “delete rule” message destined for a particular service instance of the data plane component, with a forwarding table index identifying the rule to be deleted. The “delete rule” message can then be routed to the appropriate service instance and the service instance can directly delete the rule from its forwarding table, without involving the data plane component's management processor.

Further, in scenarios where the data plane component and/or the control plane component are restarted (e.g., go from a down to up state), the control plane component can send a “flush” message to the data plane component instructing that component to flush all of the existing forwarding rules for a particular service instance, for a particular egress port, or for all service instances. As with the “add rule” and “delete rule” messages, the data plane component can process this “flush” message without involvement/orchestration by the management processor.

### 3. Efficient Rule Programming in a Network Visibility System

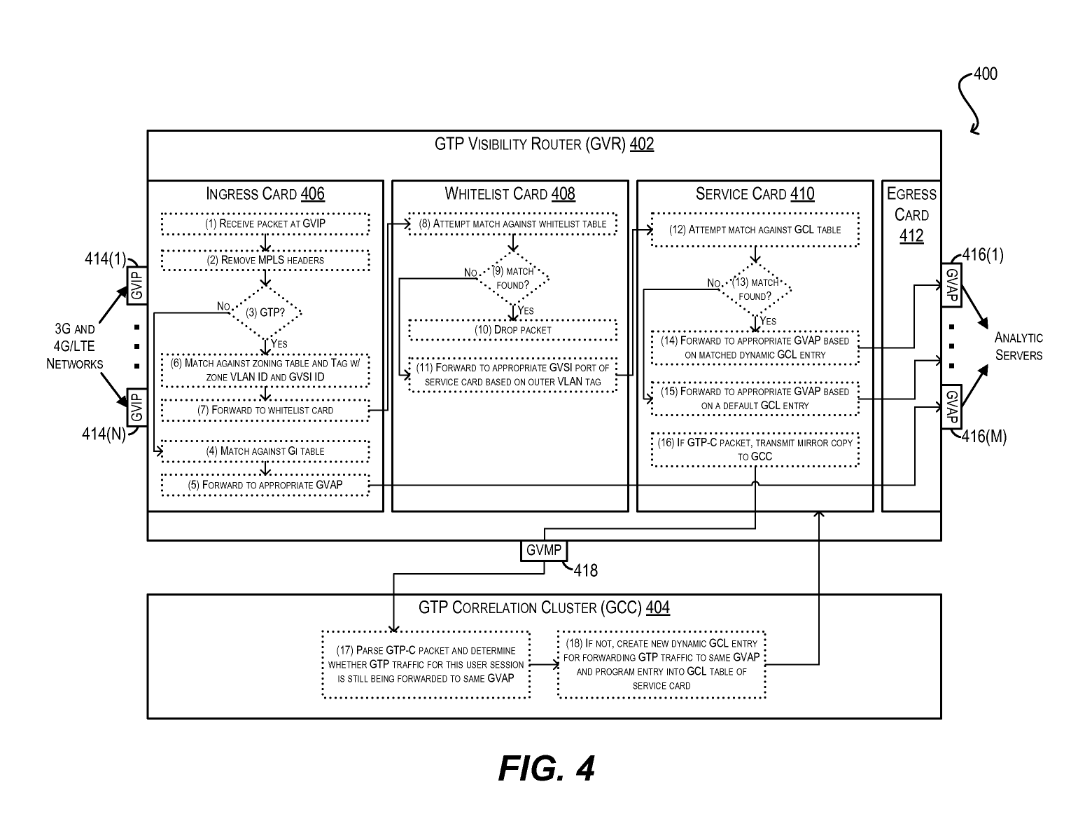

While the high-level workflow of FIG. 3 provides a general framework for enabling efficient programming of packet forwarding rules in a network system comprising a control plane component and a data plane component, they specific types of rules that are programmed via this workflow may vary depending on the features and architectural details of the network system. FIG. 4 depicts a specific implementation of a network visibility system (400) that is configured to intelligently distribute GTP traffic originating from mobile (e.g., 3G and/or 4G/LTE) networks to one or more analytic servers, as well as a runtime workflow that may be performed within system 400 according to an embodiment. The operation of network visibility system 400 is explained below. The subsequent figures and subsections then disclose a workflow for efficiently programming “dynamic GCL” rules (described below) in the context of system 400.

### 3.1 System Architecture and Runtime Workflow

As shown in FIG. 4, GVR 402 of network visibility system 400 includes an ingress card 406, a whitelist card 408, a service card 410, and an egress card 412. In a particular embodiment, each card 406-412 represents a separate line card or I/O module in GVR 402. Ingress card 406 comprises a number of ingress (i.e., “GVIP”) ports 414(1)-(N), which are communicatively coupled with one or more 3G and/or 4G/LTE mobile networks (e.g., networks 206 and 208 of FIG. 2). Further, egress card 412 comprises a number of egress (i.e., “GVAP”) ports 416(1)-(M), which are communicatively coupled with one or more analytic servers (e.g., servers 210(1)-(M) of FIG. 2). Although only a single instance of ingress card 406, whitelist card 408, service card 410, and egress card 412 are shown, it should be appreciated that any number of these cards may be supported.

In operation, GVR 402 can receive an intercepted (i.e., tapped) network packet from 3G network 206 or 4G/LTE network 208 via a GVIP port 414 of ingress card 406 (step (1)). At steps (2) and (3), ingress card 406 can remove the received packet's MPLS headers and determine whether the packet is a GTP packet (i.e., a GTP-C or GTP-U packet) or not. If the packet is not a GTP packet, ingress card 406 can match the packet against a “Gi” table that contains forwarding rules (i.e., entries) for non-GTP traffic (step (4)). Based on the Gi table, ingress card 406 can forward the packet to an appropriate GVAP port 416 for transmission to an analytic server (e.g., an analytic server that has been specifically designated to process non-GTP traffic) (step (5)).

On the other hand, if the packet is a GTP packet, ingress card 406 can match the packet against a “zoning” table and can tag the packet with a zone VLAN ID (as specified in the matched zoning entry) as its inner VLAN tag and a service instance ID (also referred to as a “GVSI ID”) as its outer VLAN tag (step (6)). In one embodiment, the zone VLAN ID is dependent upon: (1) the ingress port (GVIP) on which the packet is received, and (2) the IP address range of the GGSN associated with the packet in the case of a 3G network, or the IP address range of the SGW associated with the packet in the case of a 4G/LTE network. Thus, the zone tag enables the analytic servers to classify GTP packets based on this [GVIP, GGSN/SGW IP address range] combination. In certain embodiments, the GTP traffic belonging to each zone may be mapped to two different zone VLAN IDs depending whether the traffic is upstream (i.e., to GGSN/SGW) or downstream (i.e., from GGSN/SGW) traffic. Once tagged, the GTP packet can be forwarded to whitelist card 408 (step (7)).

At steps (8) and (9), whitelist card 408 can attempt to match the inner IP addresses (e.g., source and/or destination IP addresses) of the GTP packet against a “whitelist” table. The whitelist table, which may be defined by a customer, comprises entries identifying certain types of GTP traffic that the customer does not want to be sent to analytic servers 210(1)-(M) for processing. For example, the customer may consider such traffic to be innocuous or irrelevant to the analyses performed by analytic servers 210. If a match is made at step (9), then the GTP packet is immediately dropped (step (10)). Otherwise, the GTP is forwarded to an appropriate service instance port (GVSI port) of service card 410 based on the packet's GVSI ID in the outer VLAN tag (step (11)). Generally speaking, service card 410 can host one or more service instances, each of which corresponds to a separate GVSI port and is responsible for processing some subset of the incoming GTP traffic from 3G network 206 and 4G/LTE network 208 (based on, e.g., GGSN/SGW). In a particular embodiment, service card 410 can host a separate service instance (and GVSI port) for each packet processor implemented on service card 410.

At steps (12) and (13), service card 410 can receive the GTP packet on the GVSI port and can attempt to match the packet against a “GCL” table defined for the service instance. The GCL table can include forwarding entries that have been dynamically created by GCC 404 for ensuring that GTP packets belonging to the same user session are all forwarded to the same analytic server (this is the correlation concept described in the Background section). The GCL table can also include default forwarding entries. If a match is made at step (13) with a dynamic GCL entry, service card 410 can forward the GTP packet to a GVAP port 416 based on the dynamic entry (step (14)). On the other hand, if no match is made with a dynamic entry, service card 410 can forward the GTP packet to a GVAP port 416 based on a default GCL entry (step (15)). For example, the default rule or entry may specify that the packet should be forwarded to a GVAP port that is statically mapped to a GGSN or SGW IP address associated with the packet.

In addition to performing the GCL matching at step (13), service card 410 can also determine whether the GTP packet is a GTP-C packet and, if so, can transmit a copy of the packet to GCC 404 (step (16)). Alternatively, this transmission can be performed by whitelist card 408 (instead of service card 410). In a particular embodiment, the copy of the GTP-C packet can be sent via a separate minor port, or “GVMP,” 418 that is configured on GVR 402 and connected to GCC 404. Upon receiving the copy of the GTP-C packet, GCC 404 can parse the packet and determine whether GTP traffic for the user session associated with the current GTP-C packet will still be sent to the same GVAP port as previous GTP traffic for the same session (step (17)). As mentioned previously, in cases where a user roams, the SSGN source IP address for GTP packets in a user session may change, potentially leading to a bifurcation of that traffic to two or more GVAP ports (and thus, two or more different analytic servers). If the GVAP port has changed, GCC 404 can determine a new dynamic GCL entry that ensures all of the GTP traffic for the current user session is sent to the original GVAP port. GCC 404 can then cause this new dynamic GCL entry to be programmed into the dynamic GCL table of service card 410 (step (18)). Thus, all subsequent GTP traffic for the same user session will be forwarded based on this new entry at steps (12)-(14).

### 3.2 Programming of Dynamic GCL Rules/Entries

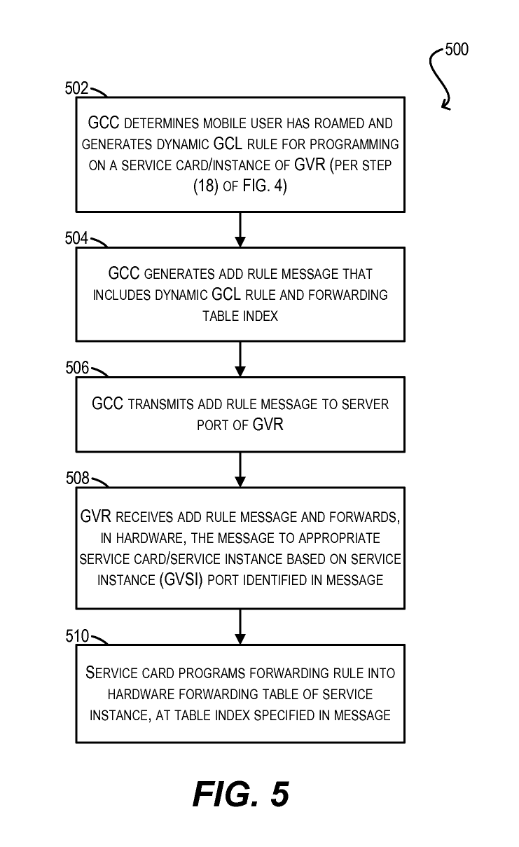

With the system architecture and runtime workflow of FIG. 4 in mind, FIG. 5 depicts a workflow 500 for that can performed by GCC 404 and GVR 402 of network visibility system 400 for efficiently programming dynamic GCL rules/entries onto GVR 402 (per step (18) of FIG. 4) according to an embodiment. With this workflow, GCC 404 can cause such dynamic GCL rules to be directly programmed into the forwarding table of a target service instance of GVR 402, without involving the GVR's management processor. Thus, this workflow enables GCC 404 to completely bypass the management layer of GVR 402 during the rule programming process, resulting in greater speed and scalability.

In one embodiment, UDP can be used as the underlying network protocol for the communication between GCC 404 and GVR 402 in workflow 500. In other embodiments, other types of network protocols can be used.

Starting with block 502, GCC 404 can determine that a mobile user has roamed to a new wireless service area (covered by a new SGSN) in the context of a single GTP session, and thus can generate a dynamic GCL rule for forwarding future GTP-U traffic from that user to the same GVAP port (and thus, analytic server) used before the roaming occurred. As part of generating this dynamic GCL rule, GCC 404 can identify the service instance of GVR 404 where the rule should be programmed, as well as a table index of the service instance's forwarding table that will hold the new rule. As noted previously, GCC 404 can be made aware of the available forwarding table index range for each service instance of GVR 402 via a communication exchange that occurs upon boot-up/initialization.

At block 504, GCC 404 can generate a “add rule” message that includes the dynamic GCL rule and the selected forwarding table index. This message can specify a destination address reflecting an IP address of GVR 402, as well as a UDP port assigned to the service instance (i.e., the service instance's GVSI port). Then, at block 506, GCC 404 can send the “add rule” message to GVR 402.

At block 508, GVR 502 can receive the “add rule” message on a server port corresponding to the destination IP address in the message and can forward, in hardware, the message to an appropriate service card/service instance (i.e., target service card/instance) based on the GVSI port. As mentioned previously, this step of forwarding the message “in hardware” means that the message is not sent to to the central management processor of GVR 402; instead, the message is forwarded directly to, e.g., a CPU residing on the target service card/instance. Accordingly, the latency and overhead that is typically incurred by involving the management processor can be avoided. Finally, upon receiving the “add rule” message, the CPU of the target service card/service instance can program the dynamic GCL rule contained in the message into the service instance's associated forwarding table, at the table index specified in the message (block 510).

Although not shown in FIG. 5, if GCC 504 determines at block 502 that a dynamic GCL rule was previously installed onto GVR 502 for the associated user session, GCC 404 can send out a “delete rule” message (prior to transmitting the “add rule” message at block 506) instructing GVR 402 to delete the previous dynamic GCL rule. This avoids any potential conflicts with the new rule.

Further, in scenarios when GVR 402 and GCC 404 are restarted (e.g., go from a down to up state), GCC 404 can send a “flush” message to GVR 402 instructing the GVR to flush the existing dynamic GCL entries for a particular GVSI, a particular GVAP, or all GVSIs/GVAPs in its forwarding tables.

### 4. Network Switch

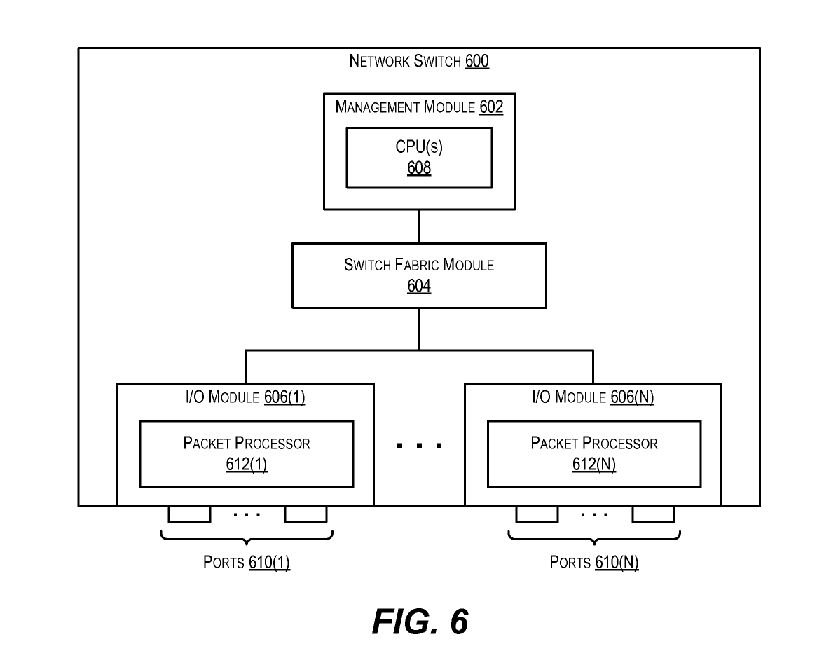

FIG. 6 depicts an exemplary network switch 600 according to an embodiment. Network switch 600 can be used to implement, e.g., GVR 202/402 of FIGS. 2 and 4.

As shown, network switch 600 includes a management module 602, a switch fabric module 604, and a number of I/O modules (i.e., line cards) 606(1)-606(N). Management module 602 includes one or more management CPUs 608 for managing/controlling the operation of the device. Each management CPU 608 can be a general purpose processor, such as a PowerPC, Intel, AMD, or ARM-based processor, that operates under the control of software stored in an associated memory (not shown).

Switch fabric module 404 and I/O modules 606(1)-606(N) collectively represent the data, or forwarding, plane of network switch 600. Switch fabric module 604 is configured to interconnect the various other modules of network switch 600. Each I/O module 606(1)-606(N) can include one or more input/output ports 610(1)-610(N) that are used by network switch 600 to send and receive data packets. Each I/O module 606(1)-606(N) can also include a packet processor 612(1)-612(N). Packet processor 612(1)-612(N) is a hardware processing component (e.g., an FPGA or ASIC) that can make wire speed decisions on how to handle incoming or outgoing data packets. In a particular embodiment, I/O modules 606(1)-606(N) can be used to implement the various types of line cards described with respect to GVR 402 in FIG. 4 (e.g., ingress card 406, whitelist card 408, service card 410, and egress card 412).

It should be appreciated that network switch 600 is illustrative and not intended to limit embodiments of the present invention. Many other configurations having more or fewer components than switch 600 are possible.

### 5. Computer System

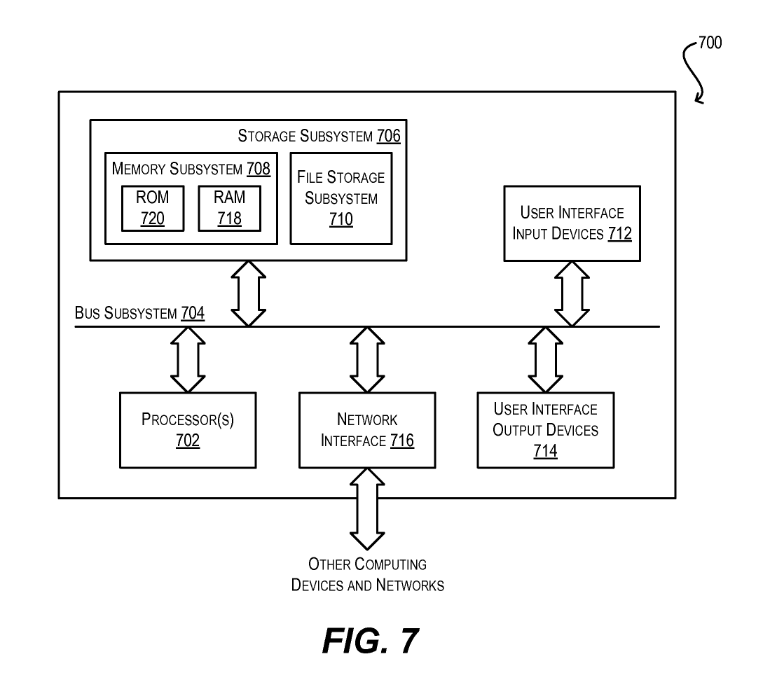

FIG. 7 is a simplified block diagram of a computer system 700 according to an embodiment. Computer system 700 can be used to implement, e.g., GCC 204/404 and/or GVR 202/402 of FIGS. 2 and 4. As shown in FIG. 7, computer system 700 can include one or more processors 702 that communicate with a number of peripheral devices via a bus subsystem 704.

These peripheral devices can include a storage subsystem 706 (comprising a memory subsystem 708 and a file storage subsystem 710), user interface input devices 712, user interface output devices 714, and a network interface subsystem 716.

Bus subsystem 704 can provide a mechanism for letting the various components and subsystems of computer system 700 communicate with each other as intended. Although bus subsystem 704 is shown schematically as a single bus, alternative embodiments of the bus subsystem can utilize multiple busses.

Network interface subsystem 716 can serve as an interface for communicating data between computer system 700 and other computing devices or networks. Embodiments of network interface subsystem 716 can include wired (e.g., coaxial, twisted pair, or fiber optic Ethernet) and/or wireless (e.g., Wi-Fi, cellular, Bluetooth, etc.) interfaces.

User interface input devices 712 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 700.

User interface output devices 714 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 700.

Storage subsystem 706 can include a memory subsystem 708 and a file/disk storage subsystem 710. Subsystems 708 and 710 represent non-transitory computer-readable storage media that can store program code and/or data that provide the functionality of various embodiments described herein.

Memory subsystem 708 can include a number of memories including a main random access memory (RAM) 718 for storage of instructions and data during program execution and a read-only memory (ROM) 720 in which fixed instructions are stored. File storage subsystem 710 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 700 is illustrative and not intended to limit embodiments of the present invention. Many other configurations having more or fewer components than computer system 700 are possible.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
determining, by a control plane component of a network system, a packet forwarding rule to be programmed into a forwarding table of a service instance residing on a data plane component of the network system; and
transmitting, by the control plane component to the data plane component, a message comprising the packet forwarding rule and a forwarding table index, wherein the forwarding table index identifies an entry in the forwarding table where the packet forwarding rule should be programmed.

2. The method of claim 1 wherein the service instance is an ASIC-based packet processor.

3. The method of claim 1 wherein a destination address of the message includes an identifier that identifies the service instance.

4. The method of claim 3 wherein the identifier is a User Datagram Protocol (UDP) port associated with the service instance.

5. The method of claim 4 wherein, upon receiving the message, the data plane component forwards the message, in hardware, to a line card hosting the packet processor, and
wherein the line card installs the packet forwarding rule into the forwarding table at the forwarding table index specified in the message.

6. The method of claim 5 wherein the message is not forwarded to, or processed by, a central management processor of the data plane component.

7. The method of claim 1 wherein the packet forwarding rule is determined dynamically by the control plane component at runtime.

8. The method of claim 1 wherein the data plane component includes one or more ingress ports communicatively coupled with one or more networks to be monitored, and one or more egress ports communicatively coupled with one or more analytic servers.

9. The method of claim 8 wherein the packet forwarding rule pertains to a user session in the one or more networks to be monitored.

10. The method of claim 8 further comprising, prior to transmitting the message to the data plane component:
determining whether another packet forwarding rule pertaining to the same user session has already been programmed into the forwarding table; and
if said another packet forwarding rule has already been programmed into the forwarding table, transmitting another message to the data plane component instructing the data plane component to delete said another packet forwarding rule.

11. The method of claim 1 further comprising, upon detecting that the control plane component or the data plane component has been restarted:
transmitting another message to the data plane component instructing the data plane component to flush one or more existing packet forwarding rules in the forwarding table.

12. The method of claim 1 wherein the data plane component is a physical network switch, and wherein the control plane component is a computer system.

13. A non-transitory computer readable storage medium having stored thereon program code executable by a control plane component of a network visibility system, the program code causing the control plane component to:
determine a packet forwarding rule to be programmed into a forwarding table of a data plane component of the network system; and
transmit, to the data plane component, a message comprising the packet forwarding rule and a forwarding table index, the forwarding table index identifying an entry in the forwarding table where the packet forwarding rule should be programmed.

14. A computer system comprising:
a processor; and
a non-transitory computer readable medium having stored thereon program code that, when executed by the processor, causes the processor to:
determine a packet forwarding rule to be programmed into a forwarding table of a data plane component of the network system; and
transmit, to the data plane component, a message comprising the packet forwarding rule and a forwarding table index, the table index identifying an entry in the forwarding table where the packet forwarding rule should be programmed.

15. A method comprising:
receiving, by a data plane component of a network system from a control plane component of the network system, a control packet directed to a service instance on the data plane component, the control packet including a packet forwarding rule and a forwarding table index;
forwarding, by the data plane component, the control packet directly to the service instance, without involving a management processor of the data plane component; and
programming, by the service instance, the packet forwarding rule into a forwarding table of the service instance, at the forwarding table index specified in the control packet.

16. A non-transitory computer readable storage medium having stored thereon program code executable by a data plane component of a network visibility system, the program code causing the data plane component to:
receive, from a control plane component of the network system, a control packet directed to a service instance on the data plane component, the control packet including a packet forwarding rule and a forwarding table index;
forward the control packet directly to the service instance, without involving a management processor of the data plane component; and
program, via the service instance, the packet forwarding rule into a forwarding table of the service instance, at the forwarding table index specified in the control packet.

17. A network switch comprising:
a first line card comprising a first packet processor; and
a second line card comprising a second packet processor,
wherein the first line card:
receives a control packet from a controller device, the control packet including a forwarding rule, an identifier identifying the second packet processor, and a forwarding table index; and
forwards, in hardware, the control packet to the second line card; and
wherein the second line card:
receives the control packet from the first line card; and
programs the forwarding rule into a forwarding table of the second packet processor, at the table index specified in the control packet.

18. The network switch of claim 17 wherein the network switch further comprises a central management processor, and wherein the first line card forwards the control packet to the second line card without involving the central management processor.
